(19) United States
(12) Patent Application Publication
(10) Pub. No.: US 2012/0045737 A1
(43) Pub. Date: Feb. 23, 2012

(54) METAL/PLASTIC HOUSING

(76) Inventor: Moe Keng Ang, Federal Territory (MY)

(21) Appl. No.: 13/318,927

(22) PCT Filed: May 4, 2010
(86) PCT No.: PCT/MY2010/000069

§ 371 Date: Nov. 4, 2011

(30) Foreign Application Priority Data
May 4, 2009 (MY) PI 20091795

(51) Int. Cl. A61C 13/225

(52) U.S. Cl. 433/177

(57) ABSTRACT

A metal/plastic housing useable for releasable denture attachment to an o-ring abutment of a dental implant, within which an elastomeric o-ring is seatable, wherein the elastomeric o-ring is an elastomeric orthodontic o-ring.

### BACKGROUND OF THE INVENTION

1. Technical Field of the Invention

This invention relates to devices for releasably mounting dentures to dental implants. Specifically this invention relates to a device utililizing an o-ring to releasably attach dentures to an o-ring abutment.

2. Description of the Prior Art

It is well known in the art to releasably attach dentures to dental implants. Gerber invented a denture attachment device way back in 1957 (U.S. Pat. No. 2,866,285) when elastomeric o-rings were not existent. He used a metal snap ring in a metal housing. The metal/plastic housing enabled the snap ring to be incorporated into an acrylic denture base whilst still retaining the snap function. The snap ring is now replaced by an elastomeric o-ring in a metal/plastic housing, which when incorporated into a denture enables releasable engagement to an o-ring abutment. Such implant o-ring abutments will have generally a constricted portion on which an o-ring slips onto and grips which o-ring can slide out of this constricted portion by a pulling action. An example of such o-ring abutment is the o-ball head design available from Imtec Corporation which U.S. Pat. No. 6,716,030 alludes to such o-ring abutment and metal housing with o-ring.

This system is excellent for releasably retaining dentures. But the patient faces a problem; o-rings wear out over time and need replacement, and for some patients frequent changes are needed. The problem is that the o-rings are not readily available and must be procured from the dental supplier through the dentist. This translates to cost and inconvenience for the patient. Some patients resort to buying o-rings from hardware suppliers and worry about carcinogens.

It will be greatly appreciated by patients if there was an o-ring that is easily available and made of oral fluid compatible material, of low cost. Such that a patient could readily stock such o-rings for replacement whenever needed. (Replacement of an o-ring is an easily learned task any patient can learn.)

### SUMMARY OF THE INVENTION

Now such an o-ring is found in the readily available elastomeric orthodontic o-ring (U.S. Pat. No. 3,530,583 granted to Klein) which are sold to patients in various colorful hues as in U.S. Pat. No. 4,038,753 granted to Klein and U.S. Pat. No. 4,946,386 granted to Kidd et al. These o-rings are cheap, readily procurable by any dentist and thence easily availed to the patient. And the material used is compatible with oral fluids.

The metal housings that house these o-rings are dimensioned to seat a correct sized o-ring. The elastomeric orthodontic o-ring which is in mass production is a very tiny o-ring. Most o-rings in mass production are of bigger size and to custom make a small o-ring like the orthodontic o-ring would be costly. Fortuitously the orthodontic o-ring is already in mass production hence readily available and cheap.

When a bigger size of a-ring is used the outer dimensions of the metal/plastic housing would be bigger and when the o-ring is of smaller size such as when the orthodontic o-ring is used, the outer dimensions of the metal/plastic housing can be correspondingly smaller. Smaller housings translate to less work for dentists in fitting dentures with such housings. This is another advantage of using a small orthodontic o-ring.

Another advantage would accrue when the housing is made of titanium/plastic. Most metal housings are of stainless steel and of concern when magnetic resonance procedures (MRI) are done. There is also concern of galvanic corrosion with stainless steel housings. There is added advantage of lower cost when the metal housing is replaced by hard plastic material such as polycarbonate, polyethylene glycol (PETG), high density polyethylene (HDPE), Teflon etc.

Fortuitously, the most commonly available size of elastomeric o-ring is size 120 which has an outer diameter of 0.012 inch or 3 mm. The circular cross sectional diameter is 0.8 mm to 0.85 mm and hence the inner diameter is about 1.3 mm which is just right to use with the Imtec o-ball head mini dental implant and any implant with o-ring abutment bearing a constriction of about 1.3 mm. A constriction of 1.2 mm to 1.4 mm should be accommodable with size 120 orthodontic o-rings. Other sizing such as 110 and 125 are also available. When the metal/plastic housing is dimensioned to fit the outer diameter of the orthodontic o-ring and the inner diameter of the orthodontic o-ring is able to grip the constriction in an o-ring abutment, the assembly is workable.

To have a metal/plastic housing with the seatable o-ring being the elastomeric orthodontic o-ring certainly confers many benefits which were not hitherto possible.

### BRIEF DESCRIPTION OF THE DRAWINGS

FIG. 1 is a length wise view of the various mentioned components, as in prior art

FIG. 2 is a cross sectional view of FIG. 1, excluding the implant

FIG. 3 is a cross sectional view of one embodiment of the current invention

### DETAILED DESCRIPTION OF THE DRAWINGS

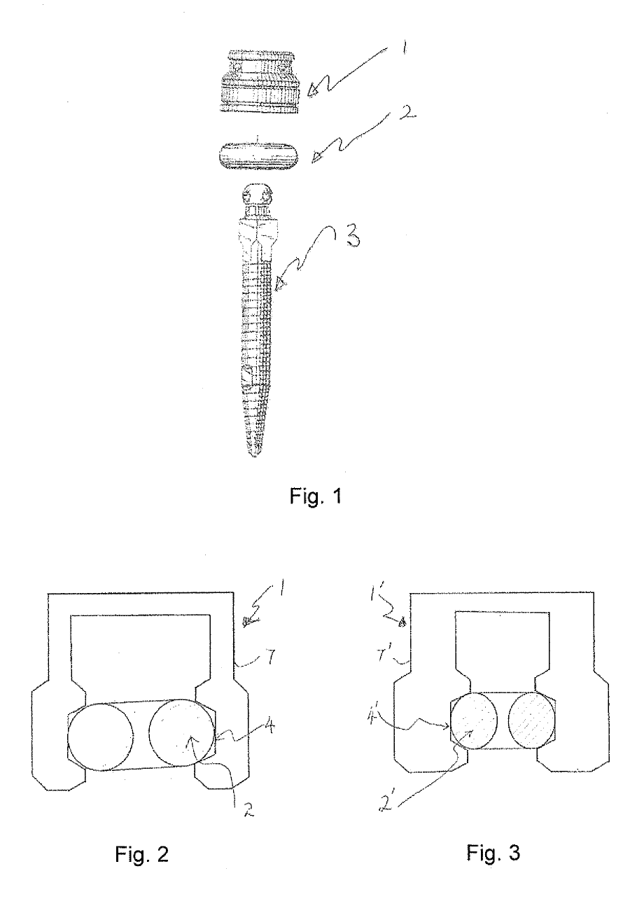

FIG. 1 is a length wise view of the various mentioned components, as in prior art. (1) is a representative denture anchoring device of prior art that utilizes an o-ring to releasably attach dentures to an o-ring abutment (5) of a dental implant (3) for comprehension.

FIG. 2 is a cross sectional view of FIG. 1, excluding the implant. Now in such devices, a housing (1) has an internal recess (6) which accommodates an annular groove (4). This annular groove (4) is sized to fit O-ring (2).

FIG. 3 shows the inventive device (1′) utilizing the inventive o-ring, namely an orthodontic ligature 120 (2′) when the annular groove (4′) is sized to fit such orthodontic ligarute 120 (2′).

1. A metal/plastic housing useable for releasable denture attachment to o-ring abutments of dental implants, within which an elastomeric o-ring is seatable wherein the elastomeric o-ring is an elastomeric orthodontic o-ring.

2. The metal/plastic housing of claim 1 wherein the o-ring is an elastomeric orthodontic o-ring size 120.

3. The metal/plastic housing of claim 1 wherein the metal used is titanium.

4. The metal/plastic housing of claim 1 wherein the metal used is stainless steel.

5. The metal/plastic housing of claim 1 wherein the plastic material used is polycarbonate.

6. The metal housing of claim 1 wherein the plastic material is high density polyethylene (HDPE).

7. The metal housing of claim 1 wherein the plastic material is polyethylene glycol (PETG).

8. The metal/plastic housing of claim 1 wherein the plastic material used is Teflon.
